(19) United States
(12) Patent Application Publication
(10) Pub. No.: US 2007/0135128 A1
(43) Pub. Date: Jun. 14, 2007

(54) Method and system for remote network identification by a mobile subscriber unit

(75) Inventors: Fred R. Villa, Gilbert, AZ (US); Valentin M. Bustamante, Gilbert, AZ (US); Glen S. Uehara, Gilbert, AZ (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/304,254

(22) Filed: Dec. 14, 2005

(51) Int. Cl. H04Q 7/20

(52) U.S. Cl. 455/445

(57) ABSTRACT

A method (400) and system (300) of indicating receipt of a call from a caller on a shared home network can include extracting (402) information from the calling party or the calling party's network indicating an originating network, sending (406) information of the originating network to a called party, and indicating (410) if the originating network belongs to the called party's shared home network. The indication can be an icon (11) or other visual indication on a mobile subscriber unit's user interface (13), or by sharing v-card or other user identification information between the calling party and the called party or by sending or providing an audible indication to the called party. The indication can be done before enabling the ability of the called party to answer a call. The step of extracting can optionally include extracting (404) information from billing information to indicate the originating network.

### FIELD

This invention relates generally to communication devices and services, and more particularly to a method and system of indicating receipt of a call from a caller on a shared home network.

### BACKGROUND

Many cellular calling plans today provide significant discounts or include within their normal subscription rates calls that are made between an originating mobile subscriber unit and a terminating mobile subscriber unit that share the same “home” network. The user of the terminating mobile subscriber unit may be taking advantage of such “In-Network Calling Rates”, but will not necessarily be aware of such savings until they receive their monthly bill. With the consolidation of network carriers or operators, there may also be instances where several different networks using different technologies, but owned by the same carrier or operator may provide an “In-Network Calling Rate.” Currently mobile subscriber unit users do not have a way of knowing for sure whether a calling currently being received is from home network or other network that is entitled to In-Network Calling Rates.

### SUMMARY

Embodiments in accordance with the present invention can provide a method and system of identifying an originating mobile subscriber unit call that is on a carrier network entitling the called party at the terminating mobile subscriber unit to receive and answer the call at “In-Network Calling Rates”.

In a first embodiment of the present invention, a method of indicating receipt of a call from a caller on a shared home network can include the steps of extracting information from the calling party or the calling party's network indicating an originating network, sending information of the originating network to a called party, indicating if the originating network belongs to the called party's shared home network. The step of indicating can be done by using an icon or other visual indication (such as a color flashing or pulsing of an icon or other indicator) on a mobile subscriber unit's user interface, or by sharing v-card information or other user identification between the calling party and the called party or by sending or providing an audible indication to the called party. The step of indicating the originating network can be done before enabling the ability of the called party to answer a call. The step of extracting can include extracting information from billing information to indicate the originating network. The step of sending the information of the originating network can be done in a number of ways including sending a data burst using a signaling protocol such as the code division multiple access (CDMA) protocol.

In a second embodiment of the present invention, a system of indicating receipt of a call from a caller on a shared home network can include a base station communicatively coupled between an originating mobile subscriber unit and a terminating mobile subscriber unit and a processor operatively coupled to the base station. The processor can be programmed to extract information from a calling party's network indicating an originating network, send information of the originating network to a called party on the terminating mobile subscriber unit, and indicate if the originating network belongs to the called party's shared home network. The system can further include a display or transducer or speaker and the processor can be programmed to provide an indication of the originating network by using an icon or other visual indication on the display or providing an audible indication. The processor can also indicate the originating network to the terminating mobile subscriber unit by sharing v-card information or other user identification between the originating mobile subscriber unit and the terminating mobile subscriber unit. The processor can further be programmed to indicate the originating network before enabling a called party at the terminating mobile subscriber to answer a call. The system can extract information from billing information to indicate the originating network to the terminating mobile subscriber unit. The system can also send information of the originating network by sending a data burst using a signal protocol such as the CDMA protocol for example.

In a third embodiment of the present invention, a wireless communication device serving as a terminating subscriber unit can include a transceiver communicatively coupled to an originating network and a processor coupled to the transceiver and operatively coupled to the network. The processor can be programmed to receive information from a calling party's network indicating the originating network and indicate if the originating network belongs to the called party's shared home network on the wireless communication device. The wireless communication device can further include a display or transducer and the processor can further programmed to provide an indication of the originating network by using an icon or other visual indication on the display or providing an audible indication for example. The wireless communication device can also indicate the originating network by exchanging v-card information or other user identification from an originating mobile subscriber unit from the originating network. The processor can also be programmed to indicate the originating network before enabling a called party at the terminating subscriber unit to answer a call. The wireless communication device can receive information regarding the originating network by extracting information from billing information to indicate the originating network to the terminating subscriber unit.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a wireless communication device including an indication of a home network connection from an originating device in accordance with an embodiment of the present invention.

FIG. 2 is another illustration of the wireless communication device including an indication of a connection not entitled to In-network calling rates in accordance with an embodiment of the present invention.

FIG. 3 is a block diagram of a system of indicating receipt of a call from a caller on a shared home network in accordance with an embodiment of the present invention.

FIG. 4 is a flow chart illustrating a method of indicating receipt of a call from a caller on a shared home network in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

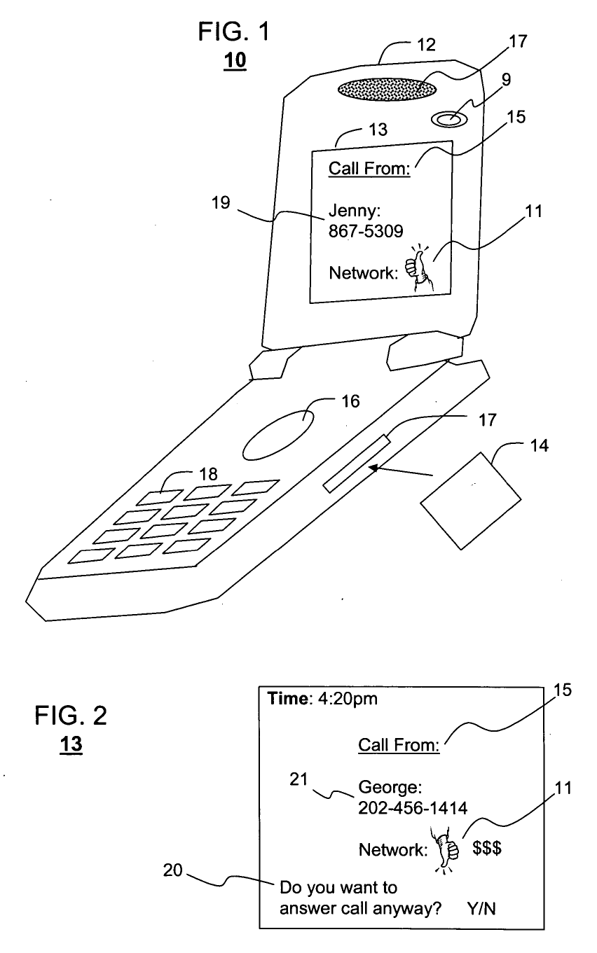

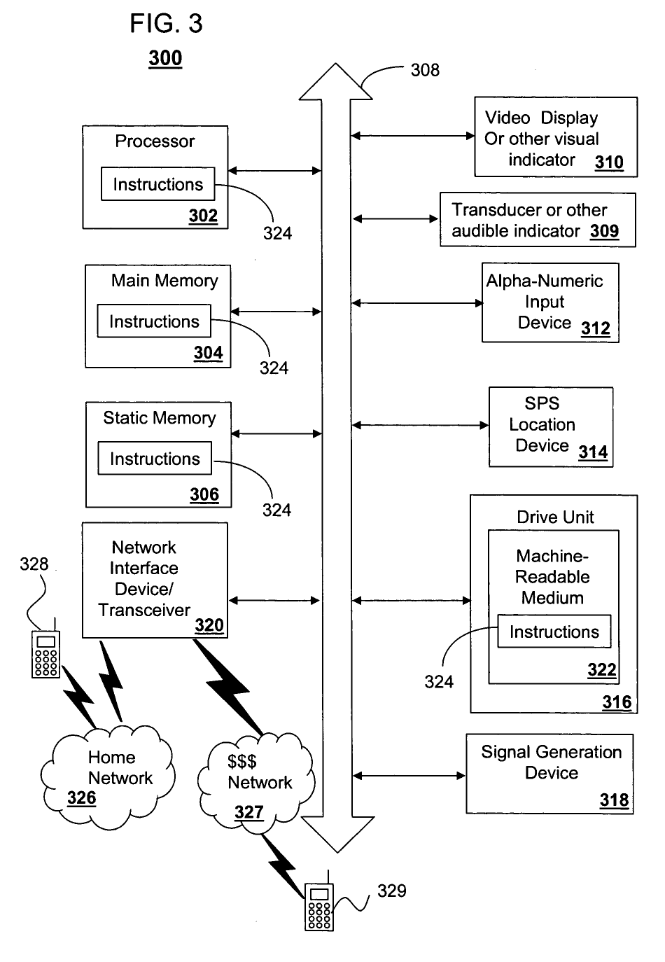

Referring to FIG. 1, an electronic device 10 such as a cellular phone, a smart phone, a cordless home phone, a personal digital assistant, a wireless messaging device, a laptop computer, or other mobile communication device can include a storage medium 14 (such as memory in the form of a memory stick, a subscriber identity module (SIM) card, flash memory, embedded memory, etc.) having stored therein a call list or other list containing contact numbers that may or may not be originating from a home network (to the device 10) entitled to “In-Network Calling Rates.” The call list can be part of a phonebook 15 illustrated on a display or user interface 13 and can include a plurality of entries 19. Each of the entries 19 can have one or more contact number or addresses that may or may not be part of the home network. The electronic device 10 can be a wireless communication device 12 further including a key or keypad 18 and/or a navigation key 16, a transducer or speaker 17 and a light indicator 9 such as a light emitting diode (LED). Note, if the wireless device 12 includes a SIM card, it can include a slot 17 for interfacing with the SIM card. The processor (see FIG. 3) in the electronic device 10 can be programmed to operate the electronic device 10 in accordance with the methods further described below. In summary, the electronic device 10 can provide an indication whether an originating call is from a home network that would entitle the terminating device (10) an “in-network calling rate.” The indication can come in many different forms, including an icon 11 on the display or user interface 13, a dedicated light indicator 9, or an audible indication via the transducer 17.

Referring to FIG. 2, the display or user interface 13 is illustrated again showing the phonebook application 15 when a call is received from an originating source 21 that is not part of the home network. The icon 11 can indicate that the call will not be entitled “In-Network Calling rates” and will cost additional fees. The user interface 13 can also give the user an option 20 to answer the call despite being subjected to higher fees. Otherwise, the user can allow the call to remain unanswered or forwarded to voicemail as desired.

Referring to FIG. 3, an electronic product or wireless device in the form of a computer system 300 can include a processor 302 (e.g., a central processing unit (CPU), a graphics processing unit (GPU, or both), a main memory 304 and a static memory 306, which communicate with each other via a bus 308. The computer system 300 may further include a transducer or other audible indicator 309, a video display unit 310 (e.g., a liquid crystal display (LCD), a flat panel, a solid state display, or a cathode ray tube (CRT)). The computer system 300 may include an input device 312 (e.g., a keyboard or keypad), a satellite position system device 314 (e.g., a GPS receiver), a disk drive unit 316, a signal generation device 318 (e.g., a speaker or remote control or microphone) and a network interface device or transceiver 320.

The disk drive unit 316 may include a machine-readable medium 322 on which is stored one or more sets of instructions (e.g., software 324) embodying any one or more of the methodologies or functions described herein, including those methods discussed below. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 or 327 can send or receive voice, video or data, and to communicate over the network 326 (or 327) using the instructions 324 to one or more communication devices 328. The network 326 in this instance can be considered the home network and the communication device 328 can be considered an originating device that shares the home network with the terminating device (300 or 320) entitling the device 300 to “In-Network Calling Rates” from calls from communication device 328. On the other hand, the terminating device 300 can also send and receive communications via a non-shared network 327. Calls to and from an originating device 329 via the network 327 to the device 300 or 320 would not be considered an “In-Network” call entitled to In-Network calling rates. In should be noted within contemplation of the embodiments herein that information can be shared among servers or basestations (326 and 327) that are not necessarily of the same technology. For example, one base station can support a CDMA-based technology while another base station can support a TDMA-based technology or a WLAN technology.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP, VoIP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

With the merging of multiple carriers and networks determining if a remote caller is on your home network can enable a user to take advantage of “In Network Calling Rates” by identifying the carrier (or conversely a non-shared carrier or non-home carrier) that the originating mobile device is associated with and allowing the user to either accept the call or force it to voice mail for later retrieval. Since Billing information is kept for roaming purposes, enough data in the network is likely available to identify the mobile's home carrier. The pertinent billing information and cellular identification information can be delivered to a terminating mobile through standard signaling, such as short data burst in the case of CDMA. This message can be received prior to the alert message and an audible tone could be played out to identify the incoming call as a call from home network or from a non-In-Network call. For instance, in the case of a newly merged cellular company where they may have dissimilar networks, if the originating network can be announced enabling the answer of the call, then the terminating user can receive and answer the call with confidence that they will be using In-Network call rates for such call. Note, a special ring tone or alert can be played when mobile subscribers of a commonly owned carrier are communicating.

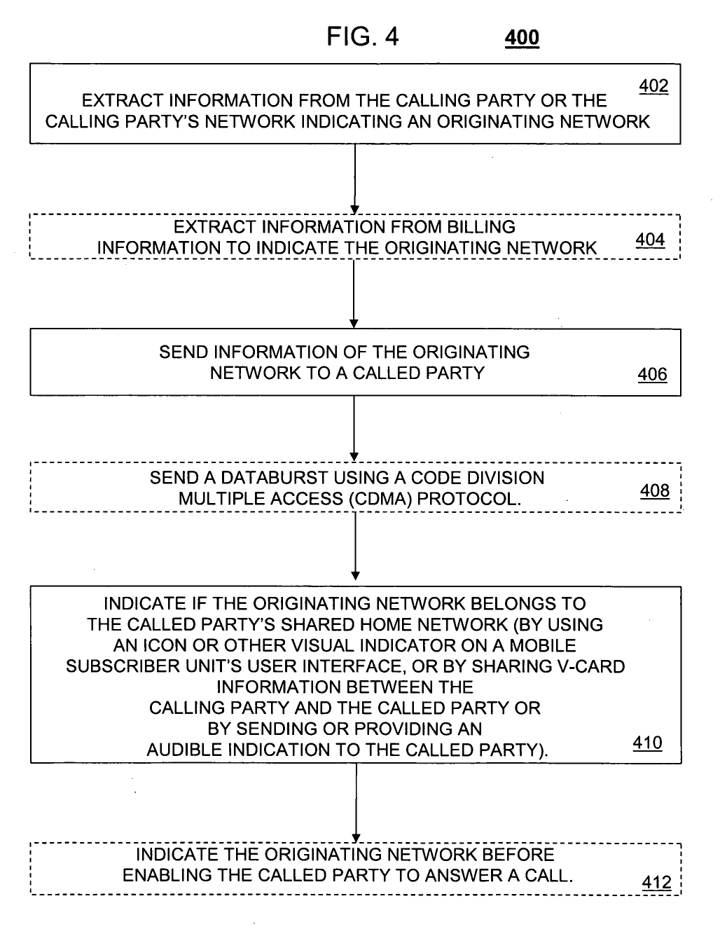

Referring to FIG. 4, a method 400 of indicating receipt of a call from a caller on a shared home network can include the step 402 of extracting information from the calling party or the calling party's network indicating an originating network, sending information of the originating network to a called party at step 406, and indicating at step 410 if the originating network belongs to the called party's shared home network. The step of indicating can be done by using an icon on a mobile subscriber unit's user interface, or by sharing v-card information between the calling party and the called party or by sending or providing an audible indication to the called party. The step of indicating the originating network can be done before enabling the ability of the called party to answer a call at step 412. The step of extracting can optionally include extracting information from billing information to indicate the originating network at step 404. Of course other means of extracting information to determine a calling party's originating network can be done including the manual storage in a phonebook by the called party indicating a particular caller's network so that subsequent calls from such caller can be handled accordingly. The step of sending the information of the originating network can be done in a number of ways including sending a data burst using a using a signaling protocol such as a code division multiple access (CDMA) protocol at step 408. Note, a data burst for CDMA is one but one example within contemplation of the embodiments. For example, VoIP is already in a data packet format and such information can theoretically be embedded in VoIP packet for use in WLAN or other scenarios.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of indicating receipt of a call from a caller on a shared home network, comprising the steps of:
extracting information from the calling party or the calling party's network indicating an originating network;
sending information of the originating network to a called party; and
indicating if the originating network belongs to the called party's shared home network.

2. The method of claim 1, wherein the step of indicating comprises the step of indicating by using an icon or other visual indication on a mobile subscriber unit's user interface.

3. The method of claim 1, wherein the step of indicating comprises the step of indicating by sharing v-card information or other user identification between the calling party and the called party.

4. The method of claim 1, wherein the method further comprises the step of indicating before enabling an ability of the called party to answer a call.

5. The method of claim 1, wherein the step of extracting comprises the step of extracting information from billing information to indicate the originating network.

6. The method of claim 1, wherein the method further comprises the step of sending a data burst using a signaling protocol.

7. The method of claim 1, wherein the step of indicating comprises the step of sending an audible indication.

8. A system of indicating receipt of a call from a caller on a shared home network, comprising:
a base station communicatively coupled between an originating mobile subscriber unit and a terminating mobile subscriber unit;
a processor operatively coupled to the base station, wherein the processor is programmed to:
extract information from a calling party's network indicating an originating network;
send information of the originating network to a called party on the terminating mobile subscriber unit; and
indicate if the originating network belongs to the called party's shared home network.

9. The system of claim 8, wherein the system further comprises a display in the terminating mobile subscriber unit and the processor is further programmed to provide an indication of the originating network by using an icon on the display.

10. The system of claim 8, wherein the system indicates the originating network to the terminating mobile subscriber unit by sharing v-card or other user information between the originating mobile subscriber unit and the terminating mobile subscriber unit.

11. The system of claim 8, wherein the processor is further programmed to indicate the originating network before enabling a called party at the terminating mobile subscriber to answer a call.

12. The system of claim 8, wherein the system extracts information by extracting information from billing information to indicate the originating network to the terminating mobile subscriber unit.

13. The system of claim 8, wherein the processor is further programmed to send information of the originating network by sending a data burst using a signaling protocol.

14. The system of claim 8, wherein the system further a transducer in the terminating mobile subscriber unit and the processor is further programmed to indicate the originating network by sending an audible indication.

15. A wireless communication device serving as a terminating subscriber unit, comprising:
a transceiver communicatively coupled to an originating network;
a processor coupled to the transceiver and operatively coupled to the network, wherein the processor is programmed to:
receive information from a calling party's network indicating the originating network; and
indicate if the originating network belongs to the called party's shared home network on the wireless communication device.

16. The wireless communication device of claim 15, wherein the wireless communication device further comprises a display and the processor is further programmed to provide an indication of the originating network by using an icon or other visual indication on the display.

17. The wireless communication device of claim 15, wherein the wireless communication device indicates the originating network by receiving v-card information or other user identification from an originating mobile subscriber unit from the originating network.

18. The wireless communication device of claim 15, wherein the processor is further programmed to indicate the originating network before enabling a called party at the terminating subscriber unit to answer a call.

19. The wireless communication device of claim 15, wherein the wireless communication device receives information by extracting information from billing information to indicate the originating network to the terminating subscriber unit.

20. The wireless communication device of claim 15, wherein the wireless communication device further comprises a transducer and the processor is further programmed to indicate the originating network by providing an audible indication.
